(19) United States
(12) Patent Application Publication
(10) Pub. No.: US 2012/0169883 A1
(43) Pub. Date: Jul. 5, 2012

(54) MULTI-STREAM VIDEO SYSTEM, VIDEO MONITORING DEVICE AND MULTI-STREAM VIDEO TRANSMISSION METHOD

(75) Inventors: Cheng-Jyh CHANG, TAIPEI HSIEN (TW); Shou-Hsuan TSAI, TAIPEI HSIEN (TW); Sen-Chiao CHANG, TAIPEI HSIEN (TW); Chi-Hsien SHIH, TAIPEI HSIEN (TW)

(73) Assignee: AVERMEDIA INFORMATION, INC., TAIPEI HSIEN (TW)

(21) Appl. No.: 12/982,920

(22) Filed: Dec. 31, 2010

(51) Int. Cl. H04N 7/18

(52) U.S. Cl. 348/159; 348/E07.085

(57) ABSTRACT

The invention discloses a multi-stream video system, a video monitoring device and a multi-stream video transmission method. The multi-stream video system includes at least one video capturing device and a video monitoring device. Each video capturing device is used for generating a plurality of video streams with different video specifications at the same time. The video monitoring device forms a telecommunication to each of the video capturing devices. When the video monitoring device performs an application operation, the video monitoring device selects and receives at least one video stream from each of the video capturing devices according to a video requirement of the application operation.

### BACKGROUND

1. Field of Invention

The present invention relates to a video monitoring system. More particularly, the present invention relates to a video monitoring system and a method thereof with multiple streams.

2. Description of Related Art

The personal security and safety of property are important issues to modern society. Many security monitoring systems are developed and widespread recently. The video capturing device with network reporting function, e.g. an IP camera, becomes main stream among those security monitoring systems, because the IP camera can be easily set up and operated to record in high resolution. With the progress of digital video technology, the recording resolution of the IP camera is higher and higher. In general, the video capturing devices cooperates with a corresponding video monitoring device to from a monitoring system, e.g. network video recorder (NVR) system. Currently a plurality of IP cameras with Mega-pixel resolution can be implemented within one NVR system.

In general, the system terminal (e.g. video monitoring device) of the NVR system may performs some processes or executes some functions based on the video information from the video capturing device (e.g. IP camera), such as it may store video information, show live video screen according to user's request, playback video information on the video monitoring device, or perform real-time detection on the video information (e.g. motion detection, face detection). During the real-time detection on the video information, the streams encoded in a video compression format (e.g. MPEG4 or H.264) from the video capturing devices must be decoded first, for obtaining RAW data of the captured video.

The decoding process for obtaining RAW data may increase the loading of the decoder unit (e.g. decoding chip, video processing chip, or microprocessor) in the video monitoring device, especially when the video information from the video capturing devices has higher video resolution, better video quality or higher video compression ratio.

When the loading of the decoder is too heavy or performance of the decoder is insufficient, it will lead to degradation of video quality, screen delay or slow reaction of the system operating interface on the video monitoring device. More serious, the video monitoring device may not completely receive video data, and the performance of the user interface on it can be unbearable, such as no response to instruction or system crash.

### SUMMARY

In order to solve the aforesaid problem, the goal of the invention is to provide a video monitoring mechanism. In the video monitoring mechanism of the invention, each video capturing device is used for generating multiple video streams with different video specifications at the same time, and the video monitoring device may dynamically select streams to its needs, so as to achieve better monitoring quality and high performance efficiency.

Therefore, an aspect of the invention is to provide a multi-stream video system, which includes at least one video capturing device and a video monitoring device. Each of the video capturing devices is used for generating a plurality of video streams at the same time. The plurality of video streams has different video specifications respectively. The video monitoring device forms a telecommunication connection to each of the video capturing devices. When the video monitoring device performs an application operation, the video monitoring device selects and receives at least one video stream of the plurality of video streams from each of the video capturing devices according to a video requirement of the application operation.

According to an embodiment of the invention, the video specification differed between the video streams includes at least one specification selected from a group consisting of a video resolution, a video quality and a video frame rate.

According to another embodiment of the invention, the application operation includes at least one operation selected from a group consisting of a multiple split-screen display operation, a partial enlargement operation, a video replay operation, a motion detection operation, a video recording operation and a remote transmission operation. In the embodiment, the video monitoring device further forms a telecommunication connection to a client device during the remote transmission operation, and then the video monitoring device selects at least one video stream from the video streams according to a video requirement of the client device, such that the video monitoring device forwards selected video stream to the client device.

According to another embodiment of the invention, the video monitoring device selects and receives two video streams from each of the video capturing devices. These two video streams include a first video stream with high specification and a second video stream with low specification. The video monitoring device performs a first application operation to the first video stream and performs a second application operation to the second video stream.

Another aspect of the invention is to provide a video monitoring device, which includes a communication module, a processor module and a judgment unit. The communication module is used for forming a telecommunication connection to at least one video capturing device. Each of the video capturing devices is used for generating a plurality of video streams, which have different video specifications respectively, at the same time. The processor module is used for performing an application operation. According to a video requirement of the application operation, the judgment unit controls the communication module to select and receive at least one video stream of the plurality of video streams from each of the video capturing devices.

According to an embodiment of the invention, the video monitoring device further includes a decoder unit for decoding the video stream. The video requirement is related to the decoding capability or decoding loading of the decoder unit.

According to another embodiment of the invention, the video monitoring device further includes a display module used for displaying the video streams. The video requirement is related to a display size of the display module, a display resolution of the display module, or a display resolution of split-screen windows on the display module.

According to another embodiment of the invention, the video monitoring device further includes a storage module used for storing the video streams. The video requirement is related to a storage capacity or a writing speed of the storage module.

According to another embodiment of the invention, the video specification differed between the video streams includes at least one specification selected from a group consisting of a video resolution, a video quality and a video frame rate.

According to another embodiment of the invention, the application operation includes at least one operation selected from a group consisting of a multiple split-screen display operation, a partial enlargement operation, a video replay operation, a motion detection operation, a video recording operation and a remote transmission operation. In the embodiment, the video monitoring device utilizes the communication module to form a telecommunication connection to a client device during the remote transmission operation. The judgment unit selects at least one video stream from the video streams according to a video requirement of the client device, and the video monitoring device forwards selected video stream to the client device.

According to another embodiment of the invention, the video monitoring device selects and receives two video streams from each of the video capturing devices. These two video streams include a first video stream with high specification and a second video stream with low specification. The video monitoring device performs a first application operation to the first video stream and performs a second application operation to the second video stream.

Another aspect of the invention is to provide a multi-stream video transmission method, which includes steps of: forming a telecommunication connection between a video monitoring device and at least one video capturing device; each of the video capturing devices generating a plurality of video streams at the same time, the plurality of video streams having different video specifications respectively; the video monitoring device analyzing the video specifications of the video streams; the video monitoring device performing an application operation; and, according to a video requirement of the application operation, the video monitoring device selecting and receiving at least one video stream of the plurality of video streams from each of the video capturing devices.

According to an embodiment of the invention, the multi-stream video transmission method further includes a step of: decoding the video streams on the video monitoring device. In this case, the video requirement is related to the decoding capability or decoding loading of the decoder unit.

According to another embodiment of the invention, the multi-stream video transmission method further includes a step of: displaying the video streams on the video monitoring device. In this case, the video requirement is related to a display size of the video monitoring device, a display resolution of the video monitoring device, or a display resolution of split-screen windows on the video monitoring device.

According to another embodiment of the invention, the multi-stream video transmission method further includes a step of: storing the video streams in the video monitoring device. In this case, the video requirement is related to a storage capacity or a writing speed of the video monitoring device.

According to another embodiment of the invention, the video specification differed between the video streams includes at least one specification selected from a group consisting of a video resolution, a video quality and a video frame rate.

According to another embodiment of the invention, the application operation includes at least one operation selected from a group consisting of a multiple split-screen display operation, a partial enlargement operation, a video replay operation, a motion detection operation, a video recording operation and a remote transmission operation.

According to another embodiment of the invention, the multi-stream video transmission method further includes a step of: the video monitoring device receiving two video streams of the plurality of video streams from each of the video capturing devices, wherein these two video streams comprise a first video stream with high specification and a second video stream with low specification; performing a first application operation to the first video stream; and, performing a second application operation to the second video stream.

### BRIEF DESCRIPTION OF THE DRAWINGS

The invention can be more fully understood by reading the following detailed description of the embodiment, with reference made to the accompanying drawings as follows:

FIG. 1 is schematic diagram illustrating a multi-stream video system according to an embodiment of the invention;

FIG. 2 is a function block diagram illustrating a video monitoring device according to an embodiment of the invention; and

FIG. 3 is a flow chart illustrating a multi-stream video transmission method according to another embodiment of the invention.

### DETAILED DESCRIPTION

In the invention, each video capturing device is utilized to provide multiple streams with different video specifications (e.g. resolution, quality, compression rate or frame rate), so as to meet the requirement of different application operations. A corresponding video monitoring device may select the optimal streams from the multiple streams, for achieving higher process efficiency. For example, low resolution stream can be used in basic video analysis and real-time previewing, and high resolution stream can be stored into a storage medium for playback function in the future. In this case, the process loading on the monitoring server terminal (i.e. video monitoring device) can be reduced. In the invention, judgment unit of the video monitoring device may choose the optimal video stream according to the video requirement of the application operation, instead of choosing video stream with fixed video specification. The detail theory of the multi-stream video system is disclosed in following paragraphs.

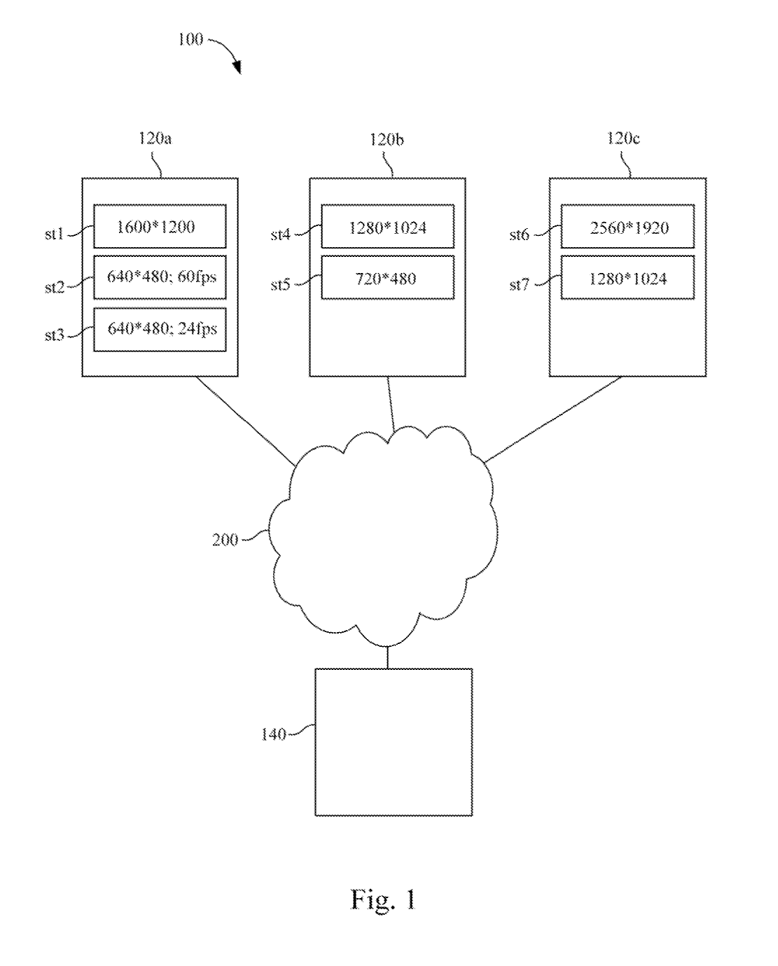

Please refer to FIG. 1, which is schematic diagram illustrating a multi-stream video system 100 according to an embodiment of the invention. As shown in FIG. 1, the multi-stream video system 100 includes multiple video capturing devices (i.e. the video capturing device 120a, the video capturing device 120b and the video capturing device 120a in this case) and a video monitoring device 140. The video monitoring device 140 forms telecommunication connections to all the video capturing devices 120a˜120c, e.g. connecting via wired/wireless internet, via wired/wireless local area network, or via cable directly. In this embodiment, the video monitoring device 140 forms telecommunication connections to all the video capturing devices 120a˜120c via internet 200. In practical applications, the multi-stream video system 100 may include more multiple video capturing devices, and the invention is not limited to three multiple video capturing devices.

In the past, traditional analog video recorder may output a video stream under QVGA specification (320*240 pixels), CIF specification (352*288 pixels), or VGA specification (640*480 pixels). However, the video specifications of modern video capturing devices (e.g. IP camera) are much higher, e.g. with 1280*960 pixels, 1600*1200 pixels, 2048*1536 pixels, 2560*1920 pixels or even higher resolution. In other words, the image in the video stream has a resolution over Mega-pixel resolution.

In general, the video capturing devices 120a˜120c in the multi-stream video system 100 can be located at different places. The video returned from the video capturing devices 120a˜120c can be arranged to display on the video monitoring device 140 at the server end. The video monitoring device 140 may perform analysis, playback, enlargement, storing operation on those returned video.

To be noticed that, in the multi-stream video system 100, each one of video capturing devices 120a˜120c may generate multiple video streams with different video specification at the same time.

For example, as shown in FIG. 1, the video capturing device 120a generates three video streams st1˜st3. The resolution of the video stream st1 is 1600*1200 pixels. The resolution of the video stream st2 is 1600*1200 pixels and the frame rate of the video stream st2 is 60 frames per second (fps). The resolution of the video stream st3 is 640*480 pixels and the frame rate of the video stream st3 is 24 frames per second (fps). The video capturing device 120b generates two video streams st4˜st5. The resolution of the video stream st4 is 1280*1024 pixels. The resolution of the video stream st5 is 720*480 pixels. The video capturing device 120c generates two video streams st6˜st7. The resolution of the video stream st6 is 2560*1920 pixels. The resolution of the video stream st5 is 1280*1024 pixels.

In aforesaid example, the difference between the video specifications of the video streams generated by the video capturing devices (120a˜120c) is mainly in video resolution for demonstration, but the invention is not limited to this. The difference of the video specification between the video streams includes at least one specification selected from a group consisting of a video resolution, a video quality and a video frame rate. In other words, different streams generated by the video capturing devices may have the same resolution (e.g. both 640*480 pixels) and have different frame rates (e.g. 60 fps, 40 fps and 24 fps), such as the video stream st2 in aforesaid example and the video stream st3, which have the same resolution 640*480 pixel and different frame rates 60 fps and 24 fps.

Besides, the video specification of the video streams can be different by the video quality. In practical applications, the video quality here can be defined by the compression rate, color depth, peak signal to noise rate (PSNR) or other equivalent video index.

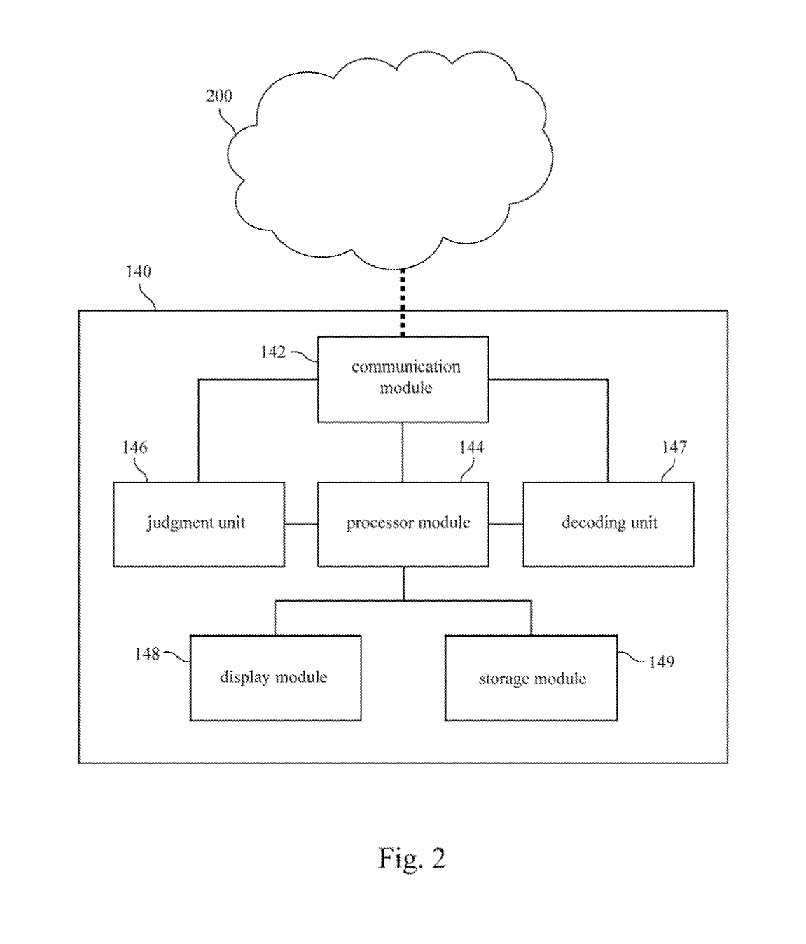

Please refer to FIG. 2 at the same time. FIG. 2 is a function block diagram illustrating a video monitoring device 140 according to an embodiment of the invention. The video monitoring device 140 includes a communication module 142, a processor module 144, a judgment unit 146, a decoder unit 147, a display module 148 and a storage module 149.

The video monitoring device 140 may connect to the internet 200 via its communication module 142, so as to form telecommunication connections to the video capturing devices 120a˜120c.

In general, before the video capturing devices 120a˜120c transmits video information (video stream st1˜st7) to the video monitoring device 140, the RAW data of the video are usually encoded, e.g. encrypted or compressed. The decoder unit 147 is used to decode the video streams st1˜st7. It will take longer time and better decoding capability to decode streams with higher resolution, higher quality or more complex encoding algorithm. Besides, it will also cause heavier loading to the decoder unit 147. The decoding execution time of the decoder unit 147 is in direct proportion to the total pixel amount of the video stream. However, the video monitoring device 140 in practical applications only receives those video streams for real-time previewing, which requires only relative low-resolution video streams most of time. In this embodiment, the decoders unit 147 can be an independent decoder chip, but the invention is not limited to this. In some practical applications, the decoder unit 147 and the processor module 144 can be integrated into one processor. In some other cases, the decoder unit 147 can be realized by software, which can be executed by the processor module 144.

The processor module 144 can be the main calculating and data processing center. In practical applications, the processor module 144 can be a processor, a process chip or a system on a chip (SoC). The processor module 144 may execute different kinds of application operations according to user instructions.

For example, the processor module 144 of the video monitoring device 140 may perform a multiple split-screen display operation (e.g. the screen can be divided into 1*2, 2*2, 4*4 split-screen windows), a partial enlargement operation (e.g. focus on a designated area or a human facial area), a video replay operation (playback), a motion detection operation, a video recording operation or a remote transmission operation according to user instructions.

According to different application operations, the processor module 144 of the video monitoring device 140 may process the video streams and transmit them to other corresponding modules and units. For example, the display module 148 is used for displaying the video streams (singular display, split-screen display, partial enlargement display, etc.); the storage module 149 is used for storing the video streams, for establishing video data base or fulfilling video playback function in the future.

In some cases, the display resolution of the display module 148 on the video monitoring device 140 can be 1600*1200 pixels for example. Therefore, when the video monitoring device 140 performs a split-screen display operation, the video monitoring device 140 may select and receive the video streams according to the resolution, which only needs to be larger or least equal to the resolution of each split-screen window, i.e. selecting relative lower resolution video streams may also achieve acceptable display effect. For example, when the video monitoring device 140 has 2*2 split-screen windows on the display module 148, each split-screen window needs only 800*600 pixels resolution. In this case, the video monitoring device 140 may select to receive the video streams over 800*600 pixels resolution, instead of selecting the video stream with the highest resolution. In another case, when there are five split-screen windows on the display module 148. One of the five split-screen windows is larger than the other fours. The video monitoring device 140 may select the video streams according to the resolution of each split-screen window independently.

Besides, common video analysis algorithms, such as motion detection, do not require really high resolution. Usually, high resolution video streams have advantages in video playback operation, biology feature identification (e.g. facial identification or iris identification), partial feature enlargement operation.

Therefore, the judgment unit 146 controls the communication module 142 to select and receive at least one video stream of the plurality of video streams from each of the video capturing devices (120a˜120c) according to a video requirement of the application operation. In this embodiment, the judgment unit 146 can be an independent chip, but the invention is not limited to this. In some practical applications, the judgment unit 146 and the processor module 144 can be integrated into one processor. In some other cases, the judgment unit 146 can be realized by software, which can be executed by the processor module 144.

There are some operational examples for demonstrating the standard of judging the video requirement of the application operation by the judgment unit 146:

(1) User wants to preview the vision from each of the video capturing device 120a˜120c, and each of the split-screen windows on the display module 148 has a resolution of 400*300 pixels:

The judgment unit 146 may select to receive the video stream st3 (640*480, 24 fps) from the video capturing device 120a, the video stream st5 (720*480) from the video capturing device 120b and the video stream st7 (1280*1024) from the video capturing device 120c.

(2) User wants to preview the vision from each of the video capturing device 120a˜120c, and each of the split-screen windows on the display module 148 has a resolution of 800*600 pixels:

The ideal resolution of the video streams should be higher than the resolution each of the split-screen windows, such that the judgment unit 146 may select to receive the video stream st1 (1600*1200) from the video capturing device 120a, the video stream st4 (1280*1024) from the video capturing device 120b and the video stream st7 (1280*1024) from the video capturing device 120c.

(3) User wants to partial enlarge the vision of the video capturing device 120a:

The judgment unit 146 may select to receive the video stream st1 (1600*1200) from the video capturing device 120a.

(4) The application operation is to detect whether the vision of the video stream is varied (e.g. motion detection):

The judgment unit 146 may select to receive the video stream st2 (640*480, 60 fps) from the video capturing device 120a, the video stream st5 (720*480) from the video capturing device 120b and the video stream st7 (1280*1024) from the video capturing device 120c. The video stream st2 (640*480, 60 fps) is selected because that it has higher frame rate, which can be useful in the motion detection.

Aforesaid examples of the judgment unit 146 judging the video requirement of the application operation are mainly related to the size or display resolution of the display module or the split-screen windows. However, the invention is not limited to this.

In other embodiments, while judging the video requirement the judgment unit 146 may also consider a decoding capability or a decoding loading of the decoder unit 147, or a storage capacity or a writing speed of the storage module 148. Besides, the judgment unit 146 is not limited to select singular video stream from one video capturing device (120a, 120b or 120c). The judgment unit 146 may select two or more video streams at the same time, and there is an operational example as follows:

(5) The multi-stream video system 100 is needed for previewing the visions of the video capturing devices 120a˜120c and recording the visions for further reviewing (playback), and users want detail video information while reviewing for security or thief-chasing purpose:

The judgment unit 146 may select to receive two different video streams (st1 and st3) from the video capturing device 120a, two different video streams (st4 and st5) from the video capturing device 120b and two different video streams (st6 and st7) from the video capturing device 120c. Among those video streams, the high standard video streams (st1, st4, st6) are not decoded by the decoder unit 147 but stored into storage module 148 directly. On the other hand, the low standard video streams (st3, sty, st7) are decoded by the decoder unit 147 and displayed on the display module 148. Only when users execute the review (playback) operation, the high standard video streams (st1, st4, st6) stored in the storage module 148 within a designated period of time are loaded and then decoded by the decoder unit 147. In this way, the quality of the vision while reviewing can be ensured, and the loading of the decoder unit 147 in normal previewing state can be reduced as well, such that the performance and interface interaction of the video monitoring device 140 can be better.

The video monitoring device 140 may perform a remote transmission operation according to user instructions. When the video monitoring device 140 performs the remote transmission operation, the video monitoring device 140 may forward incoming video stream to another client device (e.g. mobile phone, PDA, notebook, tablet or other electronic devices designated by users). The video monitoring device 140 may utilize the communication module 142 to form a telecommunication connection to the client device (not shown in figures) during the remote transmission operation. The judgment 146 unit selects at least one video stream from the video streams according to a video requirement (size of screen, processor performance, etc.) of the client device, and then the video monitoring device 140 may forward selected video stream to the client device. The theory and detail mechanism of selecting video streams may refer to aforesaid embodiments and not to be repeated here.

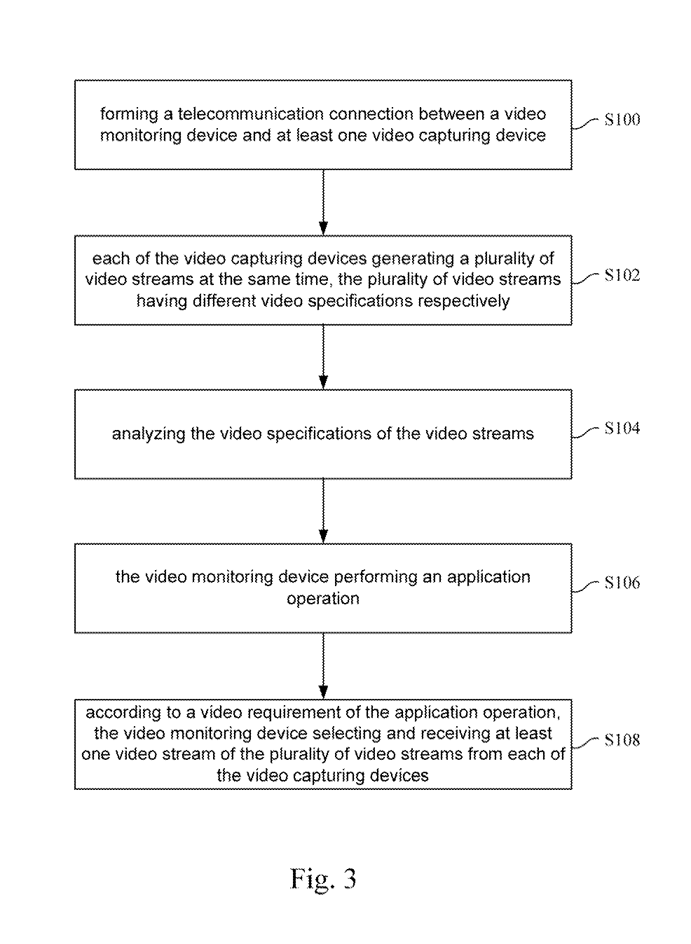

Please refer to FIG. 3, which is a flow chart illustrating a multi-stream video transmission method according to another embodiment of the invention. The multi-stream video transmission method can be used in a multi-stream video system. The multi-stream video system includes a video monitoring device and at least a video capturing device. The detail hardware structure and operating theory of the multi-stream video system can be referred to paragraphs in aforesaid embodiments.

As shown in FIG. 3, in the multi-stream video transmission method, step S100 is executed for forming a telecommunication connection between a video monitoring device and at least one video capturing device. Afterward, step S102 is executed for generating a plurality of video streams by each of the video capturing devices at the same time. The video streams have different video specifications respectively. The difference of the video specification can be a specification selected from a group consisting of a video resolution, a video quality and a video frame rate.

Afterward, step S104 is executed for analyzing the video specifications of the video streams by the video monitoring device. Afterward, step S106 is executed for performing an application operation by the video monitoring device. The application operation includes at least one operation selected from a group consisting of a multiple split-screen display operation, a partial enlargement operation, a video replay operation, a motion detection operation, a video recording operation and a remote transmission operation.

Afterward, step S108 is executed for selecting and receiving at least one video stream of the plurality of video streams from each of the video capturing devices according to a video requirement of the application operation by the video monitoring device. The video requirement is related to at least one of the a decoding capability or a decoding loading of the video monitoring device, a display size, a display resolution, a storage capacity or a writing speed of the video monitoring device.

According to another embodiment of the invention, the application operation includes at least one operation selected from a group consisting of a multiple split-screen display operation, a partial enlargement operation, a video replay operation, a motion detection operation, a video recording operation and a remote transmission operation.

Besides, in step S108 of selecting and receiving at least one video stream from the video capturing devices, the video monitoring device may select and receive two video streams from each of the video capturing devices, wherein these two video streams include a video stream with high standard of specification and a video stream with low standard of specification. Afterward, the video monitoring device may perform different application operations to the high and low standard video streams respectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A multi-stream video system, comprising:
at least one video capturing device, each of the video capturing devices being used for generating a plurality of video streams at the same time, the plurality of video streams having different video specifications respectively; and
a video monitoring device forming a telecommunication connection to each of the video capturing devices, when the video monitoring device performing an application operation, the video monitoring device selecting and receiving at least one video stream of the plurality of video streams from each of the video capturing devices according to a video requirement of the application operation.

2. The multi-stream video system of claim 1, wherein the application operation comprises at least one operation selected from a group consisting of a multiple split-screen display operation, a partial enlargement operation, a video replay operation, a motion detection operation, a video recording operation and a remote transmission operation.

3. The multi-stream video system of claim 2, wherein the video monitoring device further forms a telecommunication connection to a client device during the remote transmission operation, the video monitoring device selects at least one video stream from the video streams according to a video requirement of the client device, and the video monitoring device forwards selected video stream to the client device.

4. The multi-stream video system of claim 1, wherein the video monitoring device selects and receives two video streams from each of the video capturing devices, these two video streams comprise a first video stream with high specification and a second video stream with low specification, the video monitoring device performs a first application operation to the first video stream and performs a second application operation to the second video stream.

5. A video monitoring device, comprising:
a communication module used for forming a telecommunication connection to at least one video capturing device, each of the video capturing devices being used for generating a plurality of video streams at the same time, the plurality of video streams having different video specifications respectively;
a processor module used for performing an application operation; and
a judgment unit, according to a video requirement of the application operation, the judgment unit controlling the communication module to select and receive at least one video stream of the plurality of video streams from each of the video capturing devices.

6. The video monitoring device of claim 5, further comprising:
a display module used for displaying the video streams, wherein the video requirement is related to a display size of the display module, a display resolution of the display module, or a display resolution of split-screen windows on the display module.

7. The video monitoring device of claim 5, further comprising:
a storage module used for storing the video streams, wherein the video requirement is related to a storage capacity or a writing speed of the storage module.

8. The video monitoring device of claim 5, wherein the application operation comprises at least one operation selected from a group consisting of a multiple split-screen display operation, a partial enlargement operation, a video replay operation, a motion detection operation, a video recording operation and a remote transmission operation.

9. The video monitoring device of claim 8, wherein the video monitoring device utilizes the communication module to form a telecommunication connection to a client device during the remote transmission operation, the judgment unit selects at least one video stream from the video streams according to a video requirement of the client device, and the video monitoring device forwards selected video stream to the client device.

10. The video monitoring device of claim 5, wherein the video monitoring device selects and receives two video streams from each of the video capturing devices, these two video streams comprise a first video stream with high specification and a second video stream with low specification, the video monitoring device performs a first application operation to the first video stream and performs a second application operation to the second video stream.

11. A multi-stream video transmission method, comprising steps of:
forming a telecommunication connection between a video monitoring device and at least one video capturing device;
each of the video capturing devices generating a plurality of video streams at the same time, the plurality of video streams having different video specifications respectively;
the video monitoring device analyzing the video specifications of the video streams;
the video monitoring device performing an application operation; and
according to a video requirement of the application operation, the video monitoring device selecting and receiving at least one video stream of the plurality of video streams from each of the video capturing devices.

12. The multi-stream video transmission method of claim 11, further comprising a step of:
displaying the video streams on the video monitoring device, wherein the video requirement is related to a display size of the video monitoring device, a display resolution of the video monitoring device, or a display resolution of split-screen windows on the video monitoring device.

13. The multi-stream video transmission method of claim 11, further comprising a step of:
storing the video streams in the video monitoring device, wherein the video requirement is related to a storage capacity or a writing speed of the video monitoring device.

14. The multi-stream video transmission method of claim 11, wherein the application operation comprises at least one operation selected from a group consisting of a multiple split-screen display operation, a partial enlargement operation, a video replay operation, a motion detection operation, a video recording operation and a remote transmission operation.

15. The multi-stream video transmission method of claim 11, in the step of the video monitoring device receiving at least one video stream of the plurality of video streams from each of the video capturing devices, further comprising steps of:
the video monitoring device receiving two video streams of the plurality of video streams from each of the video capturing devices, wherein these two video streams comprise a first video stream with high specification and a second video stream with low specification;
performing a first application operation to the first video stream; and
performing a second application operation to the second video stream.
